(19) United States
(12) Patent Application Publication
(10) Pub. No.: US 2008/0163989 A1
(43) Pub. Date: Jul. 10, 2008

(54) Drive Unit For Raising And/Or Lowering A Roller Shutter

(76) Inventors: Michael Pal Sales, New South Wales (AU); Stephen Noel Corboy, South Australia (AU)

Correspondence Address: F. CHAU & ASSOCIATES, LLC, 130 WOODBURY ROAD, WOODBURY, NY, 11797, US

(21) Appl. No.: 10/592,392

(22) PCT Filed: Mar. 11, 2005
(86) PCT No.: PCT/AU2005/000351

§ 371 Date: Oct. 11, 2007

(30) Foreign Application Priority Data
Mar. 11, 2004 (AU) 2004901290

(51) Int. Cl. E05F 15/16; E06B 9/70

(52) U.S. Cl. 160/310

(57) ABSTRACT

A drive unit (10) for a roller shutter assembly is disclosed. The drive unit (10) includes at least two electrical motors (14) and a reduction gear train (12). Each electric motor (14) includes an output shaft that is mechanically coupled to an axle engaging means (20) via the reduction gear train (12). The electric motors (14) are operable to generate mechanical power generated by the combination of the electric motors (14) is coupled to the axle engaging means (20) via the reduction gear train (12) to wind a roller shutter of the roller shutter assembly onto or off an axle.

### FIELD OF INVENTION

The present invention relates to a drive unit for raising and/or lowering a roller shutter. In a typical application, the present invention may be used to raise and/or lower a roller shutter by winding the roller shutter onto and off an axle.

The roller shutter for which the present invention can be used, is typically configured to be able to close off a window or a door or another similar opening, although it will be appreciated that the shutter may also be used in situations where there is no obvious opening such as when the shutter is simply being used to form a barrier or shelter or the like.

### BACKGROUND OF THE INVENTION

Various mechanisms have been used for raising and/or lowering a roller shutter.

One such mechanism is a simple chain and sprocket type mechanism. In mechanisms of this type the chain is manually operable by a user. Operating the chain rotates the sprocket (and thus the axle) so as to wind or unwind the roller shutter. Mechanisms of this type rely on a user manually “pulling” the chain so as to wind or unwind the roller shutter. Thus, a user must have sufficient strength in order to be able to operate the mechanism. Moreover, in mechanisms of this type, the chain is typically required to be visible to the user which can detract from the overall appearance of the roller shutter assembly.

Another mechanism employ a drive unit, in the form of an electric motor with a chain and sprocket type mechanism, to raise and lower a roller shutter. However, these types of drive units typically have a configuration that is unsuitable for fitting to a roller shutter assembly in a way which does not modify the space requirements of the roller shutter assembly. Thus, mechanisms of this type have limited application.

One attempt to provide a drive unit which does not modify the space requirements of the roller shutter assembly involves enclosing an electric motor and a speed reduction gearbox within a tubular casing which is able to be fitted inside the axle of the roller shutter. Mechanisms of this type are typically referred to as ‘tubular motors’.

In tubular motors, the electric motor and the speed reduction gearbox are arranged so as to rotate a section of the tubular casing relative to a fixed support. In this way, when the tubular casing is fitted inside of the axle of the roller shutter, rotation of the section causes the axle to rotate so as to thereby wind or unwind the roller shutter.

Unfortunately, because the other components of a tubular motor are enclosed within the tubular casing, the arrangement of the components therein tends to limit the minimum length of the tubular casing which can be achieved. Accordingly, tubular motors impose a minimum length restriction on the axle of a respective roller shutter. As a result, the length of the tubular motor is often longer than desired. Thus, tubular motors are generally not suitable for use with roller shutters intended to be fitted to narrow openings (for example, a narrow window) where the tubular motor itself is longer than the width of the opening.

In addition to the above, because in general the axis of the tubular motor is typically coaxial with the axis of the output shaft of the electric motor, tubular motors generally use a planetary type gearbox. Such gearboxes have a higher parts count than other gearbox designs and are thus more complex and costly to manufacture.

It is an aim of the present invention to provide an improved drive unit for raising and/or lowering a roller shutter.

### SUMMARY OF THE INVENTION

The present invention is directed to a drive unit for a roller shutter assembly having an axle and a roller shutter connected thereto. In general terms, the drive unit includes at least two electric motors and a reduction gear train. Each electric motor includes an output shaft that is mechanically coupled to an axle engaging means via the reduction gear train. The electric motors are operable to generate mechanical power and the mechanical power generated by the combination of the electric motors is coupled to the axle engaging means via the reduction gear train to wind the roller shutter onto or off the axle.

The present invention provides a drive unit for a roller shutter assembly, the roller shutter assembly having an axle and a roller shutter connected thereto, the drive unit including:
(a) a reduction gear train including an input gear and an output gear, the reduction gear train being arranged so that the output gear is responsive to rotation of the input gear to thereby rotate an axle engaging means for winding the roller shutter onto or off the axle;
(b) at least two electric motors, each electric motor having an output shaft; and
(c) for each electric motor, a coupling means mechanically coupling the output shaft of a respective electric motor with the input gear;
   wherein each of the electric motors is operable to generate mechanical power, and wherein the mechanical power generated by the combination of the electric motors causes rotation of the input gear.

The electric motors and the reduction gear train are arranged so as to form a compact arrangement. Advantageously, the compact arrangement of the drive unit may permit it be housed within an otherwise unused space (such as a side frame) within a head box of the roller shutter assembly. In this way, fitting the drive unit to the roller shutter assembly does not normally increase the length of the head box. Accordingly, such a compact arrangement allows the drive unit to be fitted to a roller shutter assembly without imposing a minimum length restriction on the axle and thus the roller shutter assembly. Thus, it is envisaged advantageously that the drive unit will be suitable for use with roller shutter assemblies intended to be fitted to narrow openings.

The reduction gear train may include any suitable arrangement of gears. In one arrangement, the reduction gear train includes a plurality of gears which are arranged between the input gear and the output gear so as to enable the transfer of torque therebetween. As will be appreciated, the amount of reduction provided by the reduction gear train will be dependent upon the mechanical power (that is the output torque and the output RPM) which is required for winding a particular roller shutter onto and off of the axle, which in turn is dependent upon the mechanical power (that is the input torque and the RPM) which is generated by the combination of the at least two electric motors. Moreover, the size of the teeth of each gear of the reduction gear train will be dependent upon the torque which is to be transferred by a respective gear. In this respect, it is preferred that gears of the reduction gear train having smaller gear teeth are arranged with a higher positional precision relative to gears having larger gear teeth.

In an embodiment, the input gear is a spur gear. Alternatively, the input gear may be a helical gear, such as a worm. In this respect, throughout this specification, reference to the term ‘worm’ is to be understood to be reference to a helical gear having a helix angle which is preferably greater than 75 degrees. Furthermore, reference to the term ‘worm gear’ is to be understood to be reference to a helical gear that meshes with a worm such that the axis of rotation of the worm and worm gear are substantially perpendicular to each other. As will be appreciated, in relation to worms, the term helix angle is often referred to as ‘the lead angle’ which may be expressed as (90°-helix angle). Thus, a worm's lead angle equates with a worm gear's helix angle for a conventional worm gear arrangement with axes at 90 degrees to each other.

The electric motors may be any suitable type of electric motors. It is preferred that the electric motors have substantially similar performance characteristics so that in use the electric motors do not tend to act against one another and thus reduce the efficiency of the motors. One suitable type of electric motor may be a reversible motor having a no load speed in the range of 8,000 to 16,000 rpm.

The electric motors can be DC brush motors, although DC brushless motors may alternatively be employed. Advantageously, DC brush motors have a relatively low cost and thus are well suited to high volume commercial applications.

The use of at least two electric motors means that electric motors of lower power than normal may be used, due to the load requirements for winding the roller shutter onto and off the axle being shared between each of the motors, as opposed to a single motor. As a result, smaller electric motors may be utilized, providing significant flexibility in design and construction. Because the use of multiple electric motors permits the use of smaller than usual electric motors, the drive unit can be located within unused space in an end of the head box, as opposed to prior art arrangements in which the drive unit is located within the axle of the roller shutter assembly.

In one embodiment, the electric motors are ‘miniature’ DC electric motors. As will be appreciated, miniature DC electric motors typically have a low stall torque and a single motor of this kind may not generate sufficient torque for winding the roller shutter onto and off of the axle. In addition, the RPM of miniature DC electric motors is typically more than two orders of magnitude greater than the desired axle RPM. Hence, the reduction gear train converts the high RPM and low stall torque of the electric motors to a lower RPM and a higher torque which is suitable for winding the roller shutter onto and off of the axle.

It is preferred that the electric motors are arranged laterally adjacent to one another so that the respective output shafts extend in the same direction. In this arrangement, the electric motors may be configured so that the output shafts of the motors rotate in the same direction. However, in other embodiments the electric motors may be mounted so that the output shafts extend in opposite directions so that the output shafts rotate in opposite directions.

The coupling means may include a gear (hereafter referred to as the “motor gear”) which is connected to the output shaft of a respective motor. In one embodiment, each motor gear is in meshed engagement with the input gear so as to thereby mechanically couple the output shaft of a respective electric motor with the input gear. According to this embodiment, the input gear is in meshed engagement with each motor gear (the input gear in this embodiment can be termed a “common input gear”). However, in another embodiment, the motor gears may themselves be arranged in a meshed engagement and the input gear may be in meshed engagement with one of the motor gears.

In yet another embodiment, the motor gear of one of the electric motors may also be the input gear. According to this embodiment, the motor gear(s) of the other electric motor(s) are in meshed engagement with the motor gear which is also the input gear.

In an embodiment which includes a common input gear, the motor gears may form a meshed engagement with diametrically opposite sides of the common input gear so that the common input gear is located between the motor gears. Advantageously, this type of engagement balances the common input gear shaft loads so that the effect of the two electric motors is to apply a “pure” torque to the common input gear with theoretically zero shaft radial loads and therefore lower losses due to common input gear shaft friction losses.

In an embodiment, one of the motor gears may be coaxial with, and connected to, the input gear. In such arrangement, neither of the motor gears may form a meshed engagement with the input gear. In one form of this embodiment, one of the motor gears and the input gear are integrally formed.

The drive unit may be arranged so that in use the output shaft of each electric motor is aligned so as to be substantially perpendicular to the axle of the roller shutter assembly. Advantageously, such an arrangement can result in a reduced drive unit thickness. In the embodiment where the output shaft of each electric motor is aligned substantially perpendicularly to the axle of the roller shutter assembly it is preferred that the reduction gear train includes a 90° change in the axis of rotation to the axle engaging means.

In one embodiment, the change in the axis of rotation may be provided using a reduction gear train which includes a single stage worm/worm gear combination. Such a combination preferably combines the change in the axis of rotation with a compact high reduction gear stage.

It is preferred that the single stage worm/worm gear combination be located as early as possible in the reduction gear train. Thus, in one embodiment the motor gears may each include a worm and the input gear may include a worm gear.

Advantageously, an embodiment that includes a single stage worm/worm gear combination located at an early stage of the reduction gear train may reduce the number of gears operating at high RPM and thus also reduce the operating noise. However, a reduction gear train that includes a single stage worm/worm gear combination also provides additional benefits, irrespective of whether it is located at an early stage of the reduction gear train. In particular, a reduction gear train that includes a single stage worm/worm gear combination may provide a self-locking meshing engagement which permits the output gear to be rotatable by rotation of the input gear, but prevents the input gear from being rotated by rotation of the output gear. This arrangement can be beneficial because, in use, the self-locking meshing engagement will tend to lock the axle in place when the electric motors are not operated and thus tend to prevent the roller shutter from being moved.

The reduction gear train may include multiple modules. In one embodiment, the reduction gear train includes a first or primary stage module including gears having a high positional tolerance and a second or secondary stage module having gears having a lower positional tolerance relative to the first module. Such an arrangement provides additional benefits as the higher positional tolerance of the gears of the first module permits the use of gears having a smaller tooth size in the first module which in turn allows the size of the gear train to be reduced.

It is preferred that the primary stage module includes at least two electric motors for generating a mechanical power for rotating a common input gear, and an output gear that is rotationally responsive to rotation of the common input gear. Moreover, it is preferred that the secondary stage module includes an input gear for meshing with the output gear of the primary stage module, and an output gear which is rotationally responsive to rotation of the secondary stage module's input gear.

Both the primary and the secondary stage modules preferably include a respective reduction gear train. However, the gears of the primary stage module's reduction gear train preferably have improved positional precision relative to the gears of the secondary stage module's reduction gear train.

Thus, the present invention also provides a multistage drive unit for winding a roller shutter onto and off an axle, the drive unit including:
(a) a primary stage module including:
   i. a first reduction gear train including a primary stage input gear and a primary stage output gear; and
   ii. at least two electric motors for generating a mechanical power for rotating the primary stage input gear, the first reduction gear train being arranged so that the primary stage output gear is rotationally responsive to rotation of the primary stage input gear;
(b) a secondary stage module including:
   i. a second reduction gear train including a secondary stage input gear and a secondary stage output gear, the secondary stage input gear for engaging with the primary stage output gear, the secondary stage output gear for transferring a torque for winding a roller shutter onto and off an axle; and
(c) a support means for supporting the primary stage module and secondary stage module so that the primary stage output gear engages with the secondary stage input gear;
   wherein the gears of the primary stage module have improved precision relative to the gears of the secondary stage module.

It is preferred that the improved precision of the gears of the primary stage module includes improved positional precision. That is, it is preferred that the positioning of the gears of the primary stage module is more accurate than the positioning of the gears of the secondary stage module. Such improved positional precision reduces the possibility of mis-meshing and permits the use of small gear teeth.

In one embodiment, the primary stage module is a self-contained module which is separately removable from the drive unit. The primary stage module may include a housing which is supportable by the support means. It is preferred that the housing houses the two electric motors and the first reduction gear train.

Any suitable housing may be used. One suitable housing is one which is manufactured to higher tolerances than the support means (such as a moulded plastic housing) so as to provide the required improved positional tolerances when the housing is used to support at least some of the gears of the primary stage module.

In addition to the above, the housing for the primary stage module may be manufactured using different manufacturing methods than those used for the support means. For example, the housing of the primary stage module may be manufactured from plastic, whereas the support means may be cast from metal to provide other structural requirements. Such different methods may lead to further improvements in the manufacturing tolerances of the primary stage module.

It is preferred that the housing is of a two-piece construction. Indeed, a housing having a two piece construction provides a convenient way of packaging the primary stage module so as to provide the aforementioned self-contained type construction. In this embodiment, the housing may include a first part and a second part such that when the first part is fitted to the second part, at least some of the gears of the first reduction gear train are mechanically supported between the first part and the second part.

The first part and a second part may be configured so as to be interlockable using a suitable locking means. Indeed, the interlocking of the first part to the second part may give rise to additional benefits in terms of providing a clamping arrangement for securing the electric motors and the first reduction gear train between the first part and a second part.

The housing may be supported by the support means using anti-vibration mounts for isolating or dampening vibration effects caused by the operation of the electric motors. Such isolating or dampening reduces the amount of vibration which is transferred to the drive unit assembly and thus may reduce the operational noise of the drive unit assembly and provide quieter operation.

In another embodiment, the drive unit may include anti-vibration mounts for mounting the support means to the roller shutter assembly so as to reduce the amount of vibration which is transferred between the drive unit and the roller shutter assembly.

It is preferred that the housing includes a cradle for supporting the electric motors. In one embodiment, the cradle may include spaced apart supports for receiving opposite ends of the electric motors so that the electric motors are supported therebetween.

The spaced apart supports may include anti-vibration mounts for dampening vibration effects caused by the operation of the electric motors, thus reducing operational noise. In one embodiment, the anti-vibration mounts may include resilient means adapted to receive a respective end of the electric motor. In one embodiment, each resilient means may include a spring which is fitted to the cradle. In yet another embodiment the cradle may be constructed (such as by way of a two shot moulding process) so that the resilient means is integral with the cradle.

It is preferred that the resilient means provides a tuned (reduced) stiffness for reducing radiated noise attributable to the combination of the housing and the electric motors. In one embodiment, the tuned stiffness is dependent upon characteristics of the electric motor (such as the frequency of the motor and the mass of the motor).

In one embodiment, the resilient means supports each electric motor so as to substantially maintain the centre distance (that is, the distance between the axis of rotation of the motor gears) between the motor gears, but allows an amount of movement of the electric motors (and thus the motor gears) for compensating for tooth pitch errors. As will be appreciated, tooth pitch errors are the result of a small mis-location of a tooth compared to the theoretical location. Such errors may cause a change in the angular velocity of a driven gear as the particular teeth mesh, with corresponding noise and vibration.

The cradle may include an abutment means for restricting rotation of the body of electric motors about the axis of the respective output shaft. In one embodiment, the abutment means may be located between the spaced apart supports.

The abutment means may include any suitable configuration. In one embodiment, the abutment means is arranged to positively engage with a portion of the body of a respective electric motor when the electric motors are fitted to the cradle so as to prevent rotation of the electric motors when the motors are activated.

In use, the drive unit of the invention is preferably located at one end of the axle. As described previously, in a preferred form the drive unit is able to be fitted inside a head box of the roller shutter. This gives rise to benefits in terms of ease and flexibility in design and simplification of construction.

The support means may be of any suitable general configuration. For example, the support means may be a simple plate having a size that is able to support the primary stage and the secondary stage. In this form, the housing of the primary stage may be secured to the plate using a suitable arrangement, for example, brackets or fasteners.

In another form, the support means may include a base and a lid which is fitable to the base so as to support the primary stage and the secondary stage between the base and the lid.

As will be appreciated, since the primary stage module may be removed from connection with the secondary stage module, the present invention also provides a removable primary stage module for a roller shutter drive unit, the primary stage module including:
(a) at least two electric motors;
(b) a reduction gear train including an input gear and an output gear, the at least two electric motors for generating mechanical power for rotating the input gear, the output gear being rotationally responsive to rotation of the input gear;
(c) for each electric motor, a coupling means for mechanically coupling the output shaft of a respective electric motor with the input gear; and
(d) a housing means for housing the at least two electric motors and the first reduction gear train.

The present invention also provides a roller shutter assembly including:
(a) an axle;
(b) a roller shutter connected to the axle; and
(c) a drive unit for winding the roller shutter onto or off the axle, the drive unit including at least two electric motors having an output shaft mechanically coupled to an axle engaging means via a reduction gear train;
   wherein each of the electric motors is operable to generate mechanical power, and wherein the mechanical power generated by the combination of the electric motors is coupled to the axle engaging means via the reduction gear train to wind the roller shutter onto or off the axle.

### DESCRIPTION OF THE DRAWINGS

The present invention will now be described in relation to various embodiments illustrated in the accompanying drawings. However, it must be appreciated that the following description is not to limit the generality of the above description.

In the drawings:

FIG. 1 shows a perspective view of a drive unit according to a preferred embodiment of the present invention;

FIG. 2. shows a side view of the drive unit of FIG. 1;

FIG. 3 shows a plan view of the drive unit of FIG. 1;

FIG. 4 shows an end view of the drive unit of FIG. 1;

FIG. 5 shows an exploded view of the primary stage module of FIG. 1;

FIG. 6 shows an exploded view of the primary stage module and the support means of the drive unit shown in FIG. 1;

FIG. 7 shows a perspective view of a roller shutter assembly fitted with the drive unit of FIG. 1;

FIG. 8 shows a side view of a roller shutter assembly of FIG. 7;

FIG. 9 shows a front view of the roller shutter assembly of FIG. 7 with the roller shutter removed for clarity; and

FIG. 10 shows a front view of the roller shutter assembly of FIG. 7 with the roller shutter in the deployed position.

### DETAILED DESCRIPTION

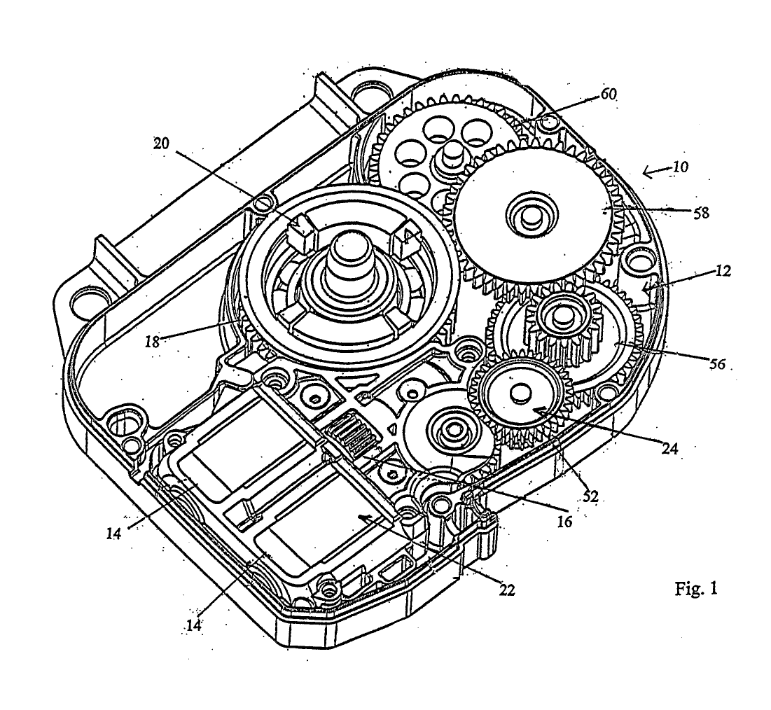

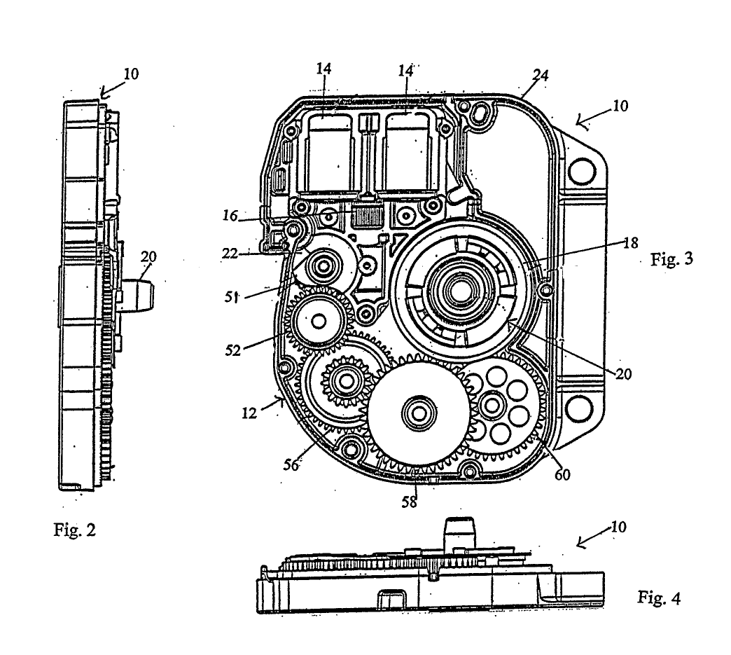

FIGS. 1 to 4 show a drive unit 10 according to a preferred embodiment of the present invention. As is shown in FIG. 1, the drive unit 10 includes a reduction gear train 12 and two electric motors 14.

As is shown in FIG. 1 and FIG. 3, the reduction gear train 12 includes an input gear 16 (shown here as a common input gear) and an output gear 18. The reduction gear train 12 shown here is arranged so that the output gear 18 is operatively associated with an axle engager 20 so that rotation of the input gear 16 causes the output gear 18, and thus the axle engager 20, to rotate. Indeed, in the illustrated embodiment, rotation of the input 16 gear causes the output gear 18 to rotate the axle engager 20 of the drive unit 10 and thus transfer a torque to the axle engaging means 20. In normal operation, mechanical power (and thus torque) required to rotate the input gear 16 is generated by the combination of the two electric motors 14.

The reduction gear train 12 shown in FIG. 1 and FIG. 3 includes multiple modules, namely a primary stage module 22 and a secondary stage module 24. It is not essential that the reduction gear train 12 include multiple modules as the reduction gear train 12 may be implemented as a single module and still provide the necessary functionality. Nevertheless, it is preferred that the reduction gear train 12 include multiple modules as this arrangement provides additional advantages over a single module implementation. In the present case, the primary stage module 22 is shown as a self-contained module which is removable from the secondary stage module 24 and thus the drive unit 10. The primary stage module 22 and the secondary stage module 24 will be described in more detail later. Although the multiple modules will be described as including a primary stage module 22 and a secondary stage module 24, it is to be understood that other arrangements are possible. Indeed, in an embodiment, the multiple modules may include a first module in place of the primary module and a second module in place of the secondary module. In such an embodiment, the first or second modules may, or may not be, primary or secondary stage modules.

The electric motors 14 shown in FIG. 1 and FIG. 3 are normally connected to an electrical power supply (not shown), such as a battery or other electrical power source. The electrical power supply will normally be located external to the roller shutter assembly itself. Accordingly, the drive unit 10 will usually include electric terminals (not shown) for connecting the electric motors 14 to a suitable electric power supply.

As will be appreciated, the performance characteristics (in particular, the torque and the speed) of the actual electric motors used will be selected according to the mechanical power and reduction which is required to be provided by the drive unit 10 to raise and/or lower a roller shutter which is associated with the drive unit 10. As will be appreciated, the mechanical power which is required to raise and/or lower the associated roller shutter is related to the speed at which the roller shutter is to be raised and/or lowered.

In the embodiment illustrated in FIGS. 1 to 4, the electric motors 14 are reversible miniature DC brush motors. Advantageously, electric motors of this type have a relatively low cost and thus are well suited to high volume commercial applications. The electric motors 14 shown in FIG. 1 and FIG. 3 have substantially the same size and similar performance characteristics so that in use the electric motors 14 do not tend to act against one another and, as a result, reduce the efficiency of the electric motors.

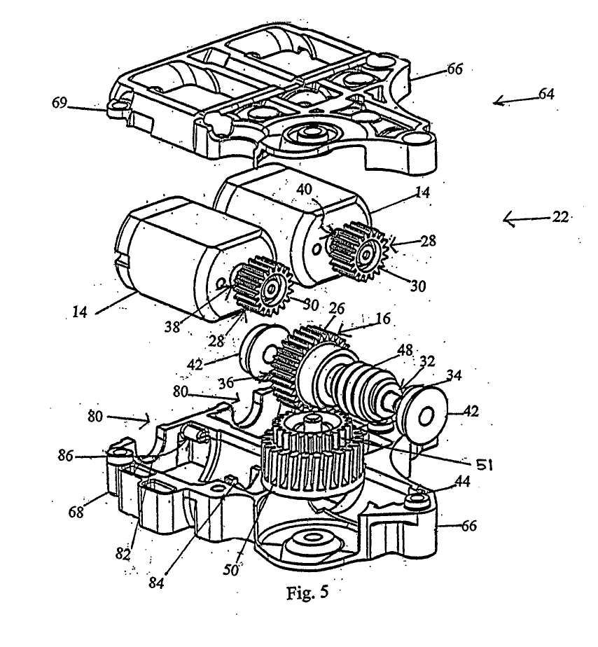

The primary stage module 22 is shown in more detail in FIG. 5. As is shown in FIG. 5, the common input gear 16 and the electric motors 14 are included with the primary stage module 22. In the illustrated embodiment, the common input gear 16 is shown as a spur gear 26 which is arranged so as to form a meshed engagement with coupling gears 28, shown here as spur gears 30 fitted to a respective output shaft 38, 40 of each electric motors 14.

As described previously, in normal operation the combination of the two electric motors 14 generates the mechanical power required to rotate the common input gear 16. In the illustrated embodiment, the electric motors 14 are mechanically coupled with the input gear 16 by coupling gears 28 (shown here as motor gears 30) so as to enable the mechanical power generated by the combination of the electric motors 14 to contribute to rotation of the input gear 16.

In the embodiment illustrated, each motor gear 30 forms a meshed engagement with the common input gear 16 so that the input gear 16 is thus common to both motor gears. However, other embodiments of the invention are envisaged in which the input gear is not common to the motor gears.

In the embodiment illustrated, the motor gears 30 are illustrated as spur gears each of which is fitted to the shaft of a respective electric motor 14. In use, each motor gear 30 converts the mechanical power generated by a respective electric motor 14 into a torque which is transferred to the common input gear 16 and ultimately to the axle engager 20 (ref. FIG. 1) of the drive unit 10.

Although in the illustrated embodiment, the motor gears 30 are shown as spur gears, it is to be understood that other types of motor gears 30 may be used. For example, in another embodiment the motor gears 30 may be worms. Of course, in embodiments which use a different type of gear as the coupling means the common input gear 16 may also be of a different type to that hereinbefore described so as to allow the electric motors 14 to maintain the afore-described mechanical coupling with the common input gear 16.

Moreover, although the preferred embodiment will be described as having a common input gear 16 which is a spur gear 26, it is not intended that the invention be so limited. Indeed, in other embodiments of the invention the common input gear may be a different type of gear. Once again, in embodiments of the invention which use a different type of gear as the common input gear, the motor gear may also be of a different type to that as hereinbefore described so as to allow the electric motors 14 to couple with the common input gear 16. However, according to the preferred embodiment of the invention, the motor gears 30 and the common input gear 16 are spur gears.

A gear arrangement which uses spur gears (or helical gears) as the motor gears 30 and a spur gear (or a helical gear) as the common input gear 16 is preferred when drive unit 10 output torque needs to be maximized. This type of arrangement results in minimum frictional losses within the motors and the reduction gear train 12. However, operational noise levels may be higher due to the use of spur or helical gears rather than worms as the motor gear.

As previously described, each motor gear 30 forms a meshed engagement with the common input gear 16 of the reduction gear train 12 so that the output shaft 38, 40 of each electric motor 14 is mechanically coupled with the common input gear 16. More specifically, the motor gears 30 and the common input gear 16 are arranged so that the motor gears 30 form a meshed engagement with diametrically opposite sides of the common input gear 16. In this preferred arrangement, the common input gear 16 is located between the motor gears 30.

It is not essential that the common input 16 gear be located between the motor gears 30 as other arrangements may be used to couple the output shafts of the electric motors 14 with the common input gear 16. Nevertheless, it is preferred that the common input gear 14 be located between the motor gears 30 because such arrangement balances common input gear 16 shaft loads about the axis of rotation of the common input gear shaft 32 so that the effect of the combination of the two electric motors is to apply a “pure” torque to the common input gear 16 with theoretically zero shaft radial loads and therefore lower losses due to common input gear shaft 32 friction losses.

As is shown in FIG. 5, the common input gear 16 is located on a shaft 32 having ends 34, 36 which are supported so as to allowed the common input gear 16 to be rotatable about an axis of rotation which is parallel to the axis of rotation of the shafts 38, 40 of the electric motors 14. In the present case, each end 34, 36 of the shaft 32 is a journal which is received within a flange mounted bearing (or the like) 42 and is thus supported by the same. The bearings 42 shown here are received within receptacles 44, 46 (hidden) of the primary stage module 22 so as to be supported therein.

As is shown in FIG. 5, the electric motors 14 are arranged adjacently to one another so that the respective output shafts 38, 40 extend in the same direction. Thus, the electric motors 14 shown here are configured so that the output shafts 38, 40 of the electric motors 14, and thus the respective motor gears 30, rotate in the same direction. In this embodiment, the axis of rotation of shafts 32, 38, 40 is perpendicular to the axis of rotation of the axle engager 20 of the drive unit 10. Such an arrangement is particularly well suited for elongate electric motors (that is, motors having a length along the axis of the shaft 38, 40 which is greater than their width) because it may result in a reduced drive unit width.

The primary stage module 22 also includes a worm 48 and a worm gear 50 combination which changes the axis of rotation relative to the axis of rotation of the common input gear 16. In the illustrated embodiment, the electric motors 14 are arranged so that in use the output shafts 38, 40 of each motor 14 is aligned substantially perpendicularly to the axle of the roller shutter assembly. The worm 48 and worm gear 50 combination combines the change in the axis of rotation change with a compact high reduction gear stage.

In the present case, the worm 48 is supported by the same shaft 32 as the common input gear 16 so that the worm 48 is arranged in a coaxial relationship with the common input gear 16. In this way, rotation of the common input gear 16 causes the worm 48 to rotate correspondingly.

The applicant has found that locating of a worm 48 and worm gear 50 combination at an early stage in the reduction gear train 12 (in the present case via the inclusion in the primary stage module 22) is particularly advantageous because such an arrangement reduces the number of gears of the reduction gear train 12 that are operating at high revolutions per minute (RPM), and thus reduces the operating noise. Moreover, the worm 48 and worm gear 50 combination also provides a self-locking meshing engagement which permits the output gear 18 (refer FIG. 1) to be rotatable by the common input gear 16 (refer FIG. 1), but which prevents the common input gear 16 (refer FIG. 1) from being rotated by the output gear 18 (refer FIG. 1).

As described previously, the primary stage module 22 includes the electric motors 14 and the common input gear 16. As is shown in FIG. 5, the primary stage module 22 also includes an output gear 51 that is coaxial with the worm gear 50 and which is rotationally responsive to rotation of the common input gear 16. As is shown in FIG. 1, the secondary stage 24 includes an input gear 52, the output gear 18 and gears 56, 58, 60.

As is shown in FIG. 3, the output gear 51 of the primary stage module 22 forms a meshed engagement with the input gear 52 of the secondary stage module 24 so that the input gear 52 of the secondary stage module 24 is rotationally responsive to rotation of the output gear 51 of the primary stage 22. Moreover, the output gear 18 is operatively associated with the input gear 52 of the secondary stage 24 via gears 56, 58, 60 so that the output gear 18 is rotationally responsive to rotation of the input gear 52 of the secondary stage module 24.

Although both the primary stage module 22 and the secondary stage module 24 each include a respective reduction gear train (which combine to form the reduction gear train of the drive unit), the gears 16, 28, 48, 51 (ref. FIG. 5) of the primary stage module 22 operate at a higher rpm that the gears 52, 56, 58, 60, 18 (ref. FIG. 1) of the secondary stage module 24 and transfer lower torque than the gears 52, 56, 58, 60, 62, 18 of the secondary stage module 24. Indeed, as the gears of the reduction gear train 12 become closer to the output gear 18 the teeth sizes of the gears becomes larger as the gear torque and thus the tooth bending loads increase.

Ordinarily, gears having smaller teeth are more likely to mis-mesh than gears having larger teeth. Indeed, the allowable change in spacing of meshed gears before mis-meshing occurs is proportional to the height of the gear teeth. However, according to the preferred embodiment, the gears of the primary stage module 22 have improved positional precision as compared to the gears of the secondary stage module 24. That is, the positioning of the gears of the primary stage module 22 is more accurate than that of the gears of the secondary stage module 24. Such an arrangement is particularly advantageous because it reduces the likelihood of mis-meshing occurring in between the gears of the primary stage module 22.

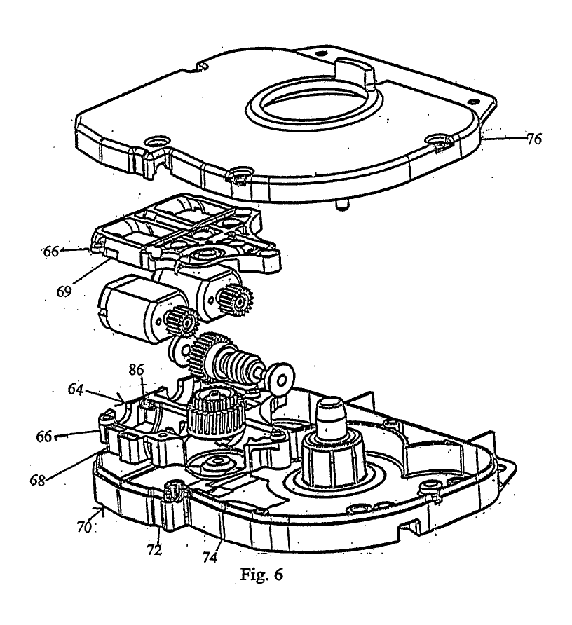

Referring now to FIG. 6, in the illustrated embodiment, the primary stage module 22 includes a housing 66. As is shown, the housing 66 of the primary stage module 22 is supported by a support 70 of the secondary stage module 24. The support 70 may be of any suitable general configuration. In the illustrated embodiment the support 70 is a cast plate 72 (shown here as base 74) having a size that is able to support the primary stage module 22 and the gears of the secondary stage module 24. In this form of the invention, the housing 66 of the primary stage 22 may be secured to the base 74 using suitable means, for example, brackets or fasteners. It will be appreciated that in another embodiment of the invention, the support 70 may also include a lid 76 which is fitable to the base 74 so as to enclose the primary stage module 22 and the secondary stage module 24 between the base 74 and the lid 76.

In terms of the primary stage module housing 66, the housing 66 shown here is a moulded housing which has been manufactured to higher tolerances than the support 70 of the secondary stage module 24. The illustrated housing 66 is of a two piece construction which includes a first part 68 and an second part 69. When the second part 69 is fitted to the first part 68, the common input gear 16 is supported between the second part 69 and the first part 68.

In the illustrated embodiment, the first part 68 and the second part 69 are configured so as to be interlockable using a locking arrangement 78. The interlocking of the first part 68 to the second part 69 may give rise to additional benefits in terms of providing a clamping arrangement for securing the electric motors 14 and the gears of the primary stage module 22 between the first part 68 and the second part 69.

The housing 66 provides a convenient way of packaging the primary stage module 22 so as to provide the aforementioned self-contained type construction. Advantageously, such a construction also enables control of tighter manufacturing tolerances and thus improved positional precision of the gears of the primary stage module 22.

The housing 66 shown in FIG. 6 is supported by the support 70 using anti-vibration mounts (not shown) which dampen vibration effects caused by the operation of the electric motors 14 and the reduction gear train 12. Such dampening reduces the amount of vibration which is transferred to the drive unit 10 assembly and thus contributes to a reduction in the operational noise of the drive unit 10.

Returning now to FIG. 5, the first part 68 of the housing 66 includes cradles 80 for supporting each electric motor 14 of the primary stage 22 so that the electric motors 14 are arranged on a plane which is parallel with the axis of rotation of the output shafts. The cradles 80 shown here include spaced apart supports 82, 84 for receiving opposite ends of the electric motors 14. When assembled, the electric motors 14 straddle the cradles 80 so that respective shafts 38, 40 of the electric motors extend outwardly from the cradles towards the common input gear 16.

High RPM, low voltage, low cost DC brush motors such as those used in the preferred embodiment of the invention often vibrate noticeably at frequencies corresponding to low integer multiples of the motor rotational frequency (typically 1 to 5). Ordinarily, this vibrational frequency is not accompanied by significant noise due to the low radiation efficiency of the motors. However, when the electric motors are coupled to a component with a higher radiation efficiency, significant noise can result.

In the present case, the housing 66 is configured so that excitation of the thereof by the electric motors 14 in a direction normal to the plane on which the electric motors are arranged is minimised so as to reduce radiated noise. According to the preferred embodiment of the invention, this may be accomplished by mounting the electric motors 14 in a housing 66 hating a tuned (reduced) stiffness and damping in a direction normal to the plane on which the electric motors 14 are arranged. However, the centre distance between the motor gears 30 and the common input gear 16 needs to be accurately maintained, especially considering the relatively small tooth sizes typical for these gears.

Thus, the housing 66 of the preferred embodiment of the invention permits the centre distance of the motor gear 30 and the common input gear 16 to be substantially maintained (that is, high stiffness), while permitting reduction of the stiffness and tuning of the damping of the housing 66.

An additional noise source can occur due to gear manufacturing tolerances. The motor gears or the common input gear can exhibit tooth pitch errors. These are characterized by small mis-location of the gear teeth compared to the theoretical location and may can result in a change in the angular velocity of a driven gear as the particular teeth mesh, with corresponding noise and vibration.

Advantageously, the reduced stiffness of the housing 66 in a direction normal to the plane on which the electric motors 14 are arranged allows for a small movement of the electric motors 14, and thus the motor gear 30, in this direction, and thus reduces the effects of tooth pitch errors whilst substantially maintaining gear pair centre distances.

As is shown in FIG. 5 and FIG. 6, each cradle 80 includes an abutment means 86 located adjacently to a respective spaced apart support 82. The abutment means 86 shown here includes a projection which positively engages with a correspondingly shaped receptacle on the body of a respective electric motor 14 so as to prevents the electric motors 14 from rotating about the axis of the respective output shaft 38 in normal use.

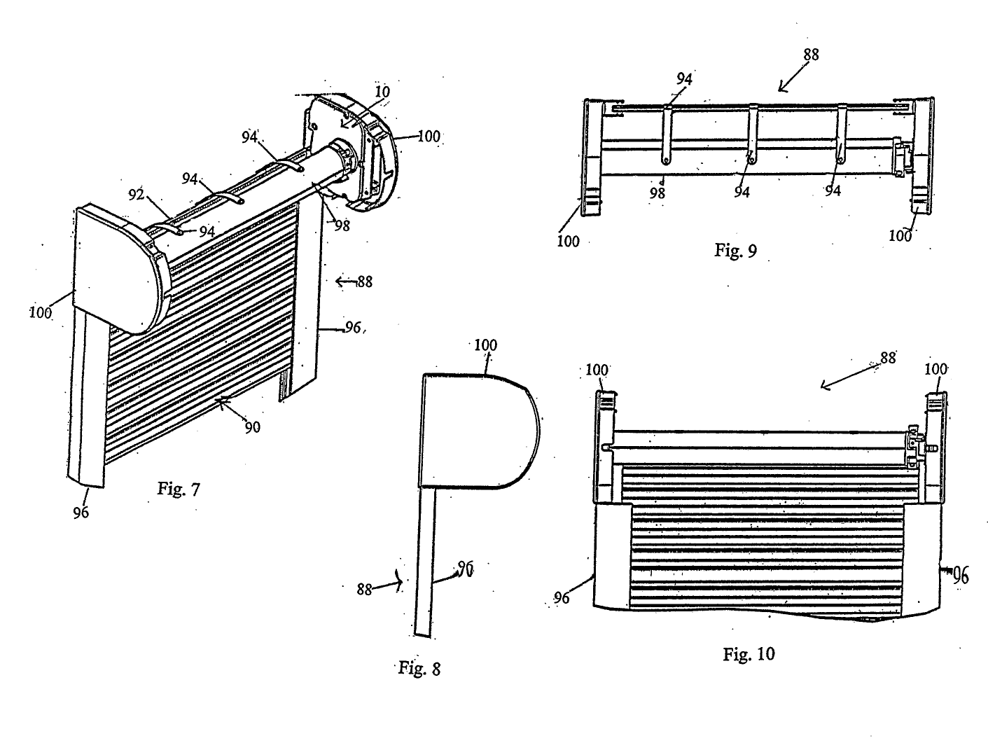

Turning now to FIGS. 7 to 10, there is shown a roller shutter assembly 88 fitted with a drive unit 10 (ref. FIG. 7) according to the preferred embodiment of the present invention. As is shown in FIG. 7, the roller shutter assembly 88 shown here includes a roller shutter 90 having an end 92 attached to an axle 98 using suitable attachment straps 94. The roller shutter 90 itself is supported between two guide members 96 so that rotation of the axle 98 causes the roller shutter 90 to slide upwardly or downwardly along a channel part of the guide members 96. As is shown, the axle 98 is located between side frames 100 of a head box (not shown). In this arrangement, the axle engager 20 (ref. FIG. 4) engages with an end of the axle 98 so that the axle 98 is responsive to rotation of the axle engager 20 to raise and/or lower the roller shutter 90.

As is shown in FIG. 7, the illustrated drive unit 10 is fitted within a side frame 100 of the roller shutter assembly 88. Thus, the installation of the drive unit 10 does not increase on the external dimensions of the roller shutter assembly 88.

Although the present invention has been described in relation to roller shutters, it is envisaged that the present invention will also be applicable to other types of shutters, such as blinds, curtains and awnings.

Finally, it will be understood that there may be other variations and modifications to the configurations described herein that are also within the scope of the present invention.

1. A drive unit for a roller shutter assembly, the roller shutter assembly having an axle and a roller shutter connected thereto, the drive unit including:
(a) at least two electric motors, each electric motor including an output shaft; and
(b) an axle engaging means mechanically coupled to each output shaft via a reduction gear train;
wherein each of the electric motors is operable to generate mechanical power, and wherein the mechanical power generated by the combination of the electric motors is coupled to the axle engaging means via the reduction gear train to wind the roller shutter onto or off the axle.

2. A drive unit according to claim 1 wherein the reduction gear train includes an input gear and an output gear, the reduction gear train being arranged so that the output gear is responsive to rotation of the input gear by the output shafts to thereby rotate the axle engaging means to wind the roller shutter onto or off the axle.

3. A drive unit according to claim 2 wherein the output shaft of each electric motor is mechanically coupled to the input gear of the reduction gear train by a motor gear.

4. A drive unit according to claim 3 wherein each motor gear is intermeshed with the input gear to mechanically couple the output shaft of a respective electric motor with the input gear.

5. A drive unit according to claim 4 wherein the motor gears intermesh with diametrically opposite sides of the input gear so that the input gear is located between the motor gears.

6. A drive unit according to claim 3 wherein the motor gears intermesh with each other and are arranged so that at least one of the motor gears intermeshes with the input gear to mechanically couple the output shaft of each electric motor with the input gear.

7. A drive unit according to claim 3 wherein the motor gears intermesh with each other and are arranged so that one of the motor gears is coaxial with the input gear.

8. A drive unit according to claim 1 wherein the output shaft of each electric motor is aligned so as to be substantially perpendicular to the axle of the roller shutter assembly so that the axis of rotation of each output shaft is perpendicular to the axis of rotation of the axle.

9. A drive unit according to claim 8 wherein the reduction gear train provides a change in the axis of rotation between the output shafts of the electric motors and the axle engaging means so that the axis of rotation of the axle engaging means is parallel with the axis of rotation of the axle.

10. A drive unit according to claim 9 wherein the reduction gear train includes a single stage worm/worm gear combination arranged to provide the change in the axis of rotation.

11. A drive unit according to claim 2, wherein the reduction gear train includes a single worm/worm gear combination.

12. A drive unit according to claim 9 wherein the single stage worm/worm gear combination permits the output gear to be rotated by rotation of the input gear, but prevents the input gear from being rotated by rotation of the output gear.

13. A drive unit according to claim 1 wherein the reduction gear train includes a first or primary stage module including gears having a high positional tolerance and a second or secondary stage module having gears having a lower positional tolerance relative to the first or primary stage module.

14. A drive unit according to claim 13 wherein the first or primary stage module and the second or secondary stage modules each include a respective reduction gear train, and wherein the gears of the first or primary stage module's reduction gear train have improved positional precision relative to the gears of the second or secondary stage module's reduction gear train.

15. A drive unit for a roller shutter assembly, the roller shutter assembly having an axle and a roller shutter connected thereto, the drive unit including:
(a) a reduction gear train including an input gear and an output gear, the reduction gear train being arranged so that the output gear is responsive to rotation of the input gear to thereby rotate an axle engaging means for winding the roller shutter onto or off the axle;
(b) at least two electric motors, each electric motor having an output shaft; and
(c) for each electric motor, a coupling means mechanically coupling the output shaft of a respective electric motor with the input gear;
wherein each of the electric motors is operable to generate mechanical power, and wherein the mechanical power generated by the combination of the electric motors causes rotation of the input gear.

16. A drive unit according to claim 15 wherein the input gear is a spur gear.

17. A drive unit according to claim 15 wherein the input gear is a helical gear.

18. A drive unit according to claim 15 wherein the electric motors are arranged laterally adjacent to one another so that the output shafts extend in the same direction.

19. A drive unit according to claim 15 wherein each coupling means includes a motor gear connected to the output shaft of a respective electric motor, and wherein each motor gear intermeshes with the input gear so as to mechanically couple the output shaft of a respective electric motor with the input gear.

20. A drive unit according to claim 19 wherein the motor gears intermesh with diametrically opposite sides of the input gear so that the input gear is located between the motor gears.

21. A drive unit according to claim 15 wherein each coupling means includes a motor gear connected to the output shaft of a respective electric motor, the motor gears intermeshing with each other and arranged so that at least one of the motor gears intermeshes with the input gear to mechanically couple the output shaft of each electric motor with the input gear.

22. A drive unit according to claim 15 wherein each coupling means includes a motor gear connected to the output shaft of a respective electric motor.

23. A drive unit according to claim 15 wherein the output shaft of each electric motor is aligned so as to be substantially perpendicular to the axle of the roller shutter assembly so that the axis of rotation of each output shaft is perpendicular to the axis of rotation of the axle.

24. A drive unit according to claim 23 wherein the reduction gear train provides a change in the axis of rotation between the output shafts of the electric motors and the axle engaging means so that the axis of rotation of the axle engaging means is parallel with the axis of rotation of the axle.

25. A drive unit according to claim 24 wherein the reduction gear train includes a single stage worm/worm gear combination arranged to provide the change in the axis of rotation.

26. A drive unit according to claim 25 wherein the worm is the coupling means and the worm gear is the input gear.

27. A drive unit according to claim 15, wherein the reduction gear train includes a single worm/worm gear combination.

28. A drive unit according to claim 25 wherein the single stage worm/worm gear combination permits the output gear to be rotated by a rotation of the input gear, but prevents the input gear from being rotated by a rotation of the output gear.

29. A drive unit according to claim 15 wherein the reduction gear train includes a first or primary stage module including gears having a high positional tolerance and a second or secondary stage module having gears having a lower positional tolerance relative to the first or primary stage module.

30. A drive unit according to claim 29 wherein the first or primary stage module and the second or secondary stage modules each include a respective reduction gear train, and wherein the gears of the first or primary stage module's reduction gear train have improved positional precision relative to the gears of the second or secondary stage module's reduction gear train.

31. A multistage drive unit for winding a roller shutter onto and off an axle, the drive unit including:
(a) a primary stage module including:
i. a first gear train including a primary stage input gear and a primary stage output gear; and
ii. at least two electric motors for generating a mechanical power for rotating the primary stage input gear, the first reduction gear train being arranged so that the primary stage output gear is rotationally responsive to rotation of the primary stage input gear;
(b) a secondary stage module including a second reduction gear train including a secondary stage input gear and a secondary stage output gear, the secondary stage input gear for engaging with the first or primary stage's output gear, the secondary stage output gear for transferring a torque for winding a roller shutter onto and off an axle; and
(c) a support means for supporting the first or primary stage module and the secondary stage module so that the primary stage output gear engages with the second or secondary stage input gear;
wherein the gears of the primary stage module have improved precision relative to the gears of the secondary stage module.

32. A multistage unit according to claim 31 wherein the improved precision of the gears of the primary stage module includes improved positional precision.

33. A multistage drive unit according to claim 31 wherein the primary stage module is a self-contained module that is separately removable from the multistage drive unit.

34. A multistage drive unit according to claim 31 wherein the primary stage module includes a housing for housing the first reduction gear train and the at least two electric motors, and wherein the housing is supported by the support means.

35. A multistage drive unit according to claim 34 wherein the housing is manufactured to a higher tolerance than the support means so that the gears of the first reduction gear train have improved positional precision relative to the gears of the second reduction gear train.

36. A multistage drive unit according to claim 34 wherein the housing includes a first part and a second part, and wherein the first part is fitted to the second part so that at least some of the gears of the first reduction gear train are mechanically supported between the first part and the second part.

37. A multistage drive unit according to claim 36 wherein the first part and a second part are configured so as to be interlockable to provide a clamping arrangement therebetween for securing the electric motors and the first reduction gear train between the first part and the second part.

38. A multistage drive unit according to claim 34 wherein the housing is supported by the support means using anti-vibration mounts for isolating or dampening vibration effects caused by the operation of the electric motors.

39. A multistage drive unit according to claim 31 wherein the drive unit includes anti-vibration mounts for mounting the support means to the roller shutter assembly so as to reduce the transfer of vibration between the drive unit and the roller shutter assembly.

40. A multistage drive unit according to claim 34 wherein the housing includes a cradle for supporting the electric motors, the cradle including spaced apart supports for receiving opposite ends of the electric motors so that the electric motors are supported therebetween, the spaced apart supports including anti-vibration mounts for dampening vibration effects caused by the operation of the electric motors.

41. A multistage drive unit according to claim 40 wherein the anti-vibration mounts include resilient means adapted to receive a respective end of the electric motor, the resilient means providing a tuned stiffness for reducing radiated noise attributable to the combination of the housing and the electric motors.

42. A multistage drive unit according to claim 40 wherein the anti-vibration mounts include resilient means adapted to receive a respective end of the electric motor, the resilient means supporting each electric motor so as to substantially maintain the centre distance between the coupling means, but allowing an amount of movement of the electric motors for compensating for tooth pitch errors.

43. A removable primary stage module for a roller shutter drive unit, the primary stage module including:
(a) at least two electric motors;
(b) a reduction gear train including an input gear and an output gear, the at least two electric motors for generating mechanical power for rotating the input gear, the output gear being rotationally responsive to rotation of the input gear;
(c) for each electric motor, a coupling means mechanically coupling the output shaft of a respective electric motor with the input gear; and
(d) a housing means housing the at least two electric motors and the first reduction gear train.

44. A roller shutter assembly including:
(a) an axle;
(b) a roller shutter connected to the axle; and
(c) a drive unit for winding the roller shutter onto or off the axle, the drive unit including at least two electric motors having an output shaft mechanically coupled to an axle engaging means via a reduction gear train;
wherein each of the electric motors is operable to generate mechanical power, and wherein the mechanical power generated by the combination of the electric motors is coupled to the axle engaging means via the reduction gear train to wind the roller shutter onto or off the axle.

45. A roller shutter according to claim 44 further including a head box for covering the axle and wherein the drive unit is fitted inside the head box and proximal to an end of the axle.

46. A drive unit according to claim 11 wherein the single stage worm/worm gear combination permits the output gear to be rotated by rotation of the input gear, but prevents the input gear from being rotated by rotation of the output gear.

47. A drive unit according to claim 27 wherein the single stage worm/worm gear combination permits the output gear to be rotated by a rotation of the input gear, but prevents the input gear from being rotated by a rotation of the output gear.
